(19) United States
(12) Patent Application Publication
(10) Pub. No.: US 2007/0143627 A1
(43) Pub. Date: Jun. 21, 2007

(54) Input device and password control method used therein

(75) Inventors: Kuan-Hong Hsieh, Shenzhen (CN); Han-Che Wang, Shenzhen (CN); Robert Han Liu, Shenzhen (CN); Wen-Chuan Lian, Shenzhen (CN); Xiao-Guang Li, Shenzhen (CN)

Correspondence Address: NORTH AMERICA INTELLECTUAL PROPERTY CORPORATION, P.O. BOX 506, MERRIFIELD, VA, 22116, US

(73) Assignee: HON HAI PRECISION INDUSTRY CO., LTD., Taipei Hsien (TW)

(21) Appl. No.: 11/309,909

(22) Filed: Oct. 27, 2006

(30) Foreign Application Priority Data
Dec. 19, 2005 (CN) 200510121007.X

(51) Int. Cl. H04L 9/00

(52) U.S. Cl. 713/183

(57) ABSTRACT

A password control method used in an input device is provided. The input device has a coordinate output circuit for outputting coordinates corresponding to a movement of the input device and a storage unit for storing information. The method includes the steps of: (a) providing the input device with a plurality of keys for operational inputs, wherein the keys are selected from the group consisting of number keys, letter keys, and a combination of number keys and letter keys; (b) comparing the operational inputs from the keys with a predetermined password; (c) generating an unlock signal if the operational inputs match the predetermined password; and (d) unlocking the locked storage unit according to the unlock signal thereby enabling a computer system to access the storage unit.

### TECHNICAL FIELD

The present invention relates to input devices and methods therewith, and particularly to a mouse with a security system and password control method used therein.

### GENERAL BACKGROUND

Along with continual development of the information industry, computers have penetrated into everyday lives of people whether work related or personal related. Computer peripheral device such as mice and memory devices have also become non-exclusive products in computer operations.

When a user operates a computer to perform data processing, a mouse plays an important role when using a graphical user interface of the computer. Through an accurate cursor control provided by the mouse, the user can maneuver information on the screen performing actions such as, selection, drag, and execution, thereby performing data editing, data cutting or pasting, documents opening or closing, and so on.

In an unrelated aspect, it is also necessary to store various kinds of electronic data in peripheral devices. Therefore, data storage devices such as flash memories, electronic erasable programmable read-only memories (EEPROMs), or magnetic recording media were developed to store the various kinds of electronic data. For example, various kinds of memory cards allow users to be able to conveniently exchange various kinds of files and documents between computers.

However, in prior arts, the cursor function of the mouse and the data storage function of the memory belong to separate peripheral devices. Nevertheless, the independent nature of these two functions may be troublesome to people, typically, someone who is often out of home or office. When people are out, they are required to carry many computer peripheral devices associated with a portable computer such as, for example, the mouse, the data storage device, and the like. As a result, the more computer peripheral devices needed, the higher possibility people may forget to bring the peripheral devices. In other words, the separation of a mouse function and a storage function creates many inconveniences for people.

Therefore, a mouse capable of storing data, namely a combination of the conventional mouse and the conventional data storage device, has been introduced recently. This mouse can be used for data access when being used as a regular mouse. While this mouse is capable of precluding the above problem in portability, another problem has been encountered that, data stored in the mouse that are mostly private and sensitive information, has no mechanism to prevent unauthorized access to the data.

What is needed, therefore, is an input device and a security method used therein, which is capable of preventing unauthorized access to the input device.

### SUMMARY

An input device with a password control function is provided. The input device has a coordinate output circuit, a plurality of keys, a storage unit, and a microcontroller. The coordinate output circuit is configured for outputting coordinates corresponding to a movement of the input device. The keys are configured for generating operational inputs when clicked and are in the form of number keys, letter keys, or in a combination of number keys and letter keys. The storage unit is configured for storing information. When the storage unit is in a locked state, the storage unit is not allowable for access, and vice versa. The microcontroller is configured for outputting the coordinates from the coordinate output circuit to a computer system connected thereto. The microcontroller further includes a password comparing module and an unlocking module. The password comparing module is configured for comparing the operational inputs from the keys with a predetermined password, and generating an unlock signal if the operational inputs match the predetermined password. The unlocking module is configured for unlocking the storage unit, thereby enabling the computer system to access the information of the storage unit.

A password control method used in an input device is also provided, wherein the input device has a coordinate output circuit for coordinate output circuit for coordinate inputs and a storage unit for storing information. The method includes the steps of: (a) providing the input device with a plurality of keys for operational inputs, wherein the keys are selected from the group consisting of number keys, letter keys, and a combination of number keys and letter keys; (b) comparing the operational inputs from the keys with a predetermined password; (c) generating an unlock signal if the operational inputs match the predetermined password; and (d) unlocking the locked storage unit according to the unlock signal thereby enabling the computer system to access the storage unit.

Other advantages and novel features will be drawn from the following detailed description with reference to the attached drawing, in which:

### BRIEF DESCRIPTION OF DRAWINGS

FIG. 1 is an exemplary schematic diagram of a hardware infrastructure of an input device having a security system in accordance with a preferred embodiment of the present invention; and

FIG. 2 is a flowchart of a preferred password control method used in the input device of FIG. 1.

### DETAILED DESCRIPTION

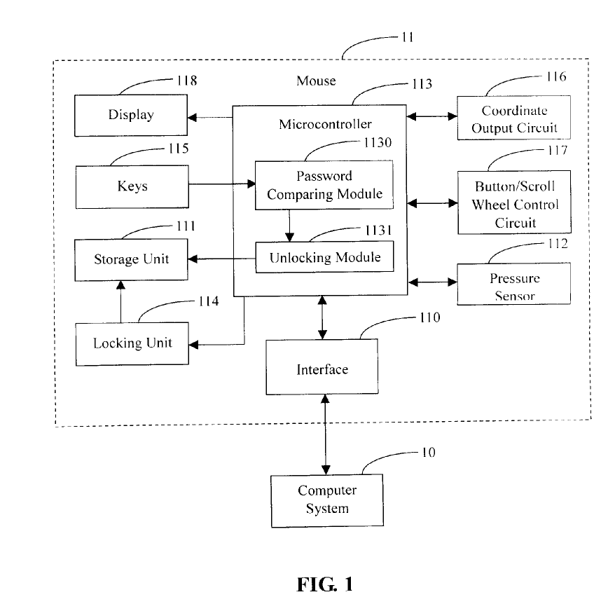

FIG. 1 is an exemplary schematic diagram of a hardware infrastructure of an input device in accordance with a preferred embodiment of the present invention. The input device 11 is a peripheral device, typically a pointing device such as, for example, a mouse, a joy stick, a track ball, etc, which not only enables control of a cursor on a display of a computer system 10 connected thereto, but also stores data. Furthermore, the input device 11 is configured with a security system therein for preventing unauthorized access to the stored data.

In this exemplary embodiment, the mouse is provided as an example. The mouse 11 has an interface 110, a storage unit 111, a pressure sensor 112, a microcontroller 113, a locking unit 114, a plurality of keys 115, a coordinate output circuit 116, a button/scroll wheel control circuit 117, and a display 118

The interface 110 is configured for performing data communication between the mouse 11 and the computer system 10. Consequently, the interface 110 can be any appropriate communication media such as, for example, a Universal Serial Bus (USB) interface, a PS/2 (Personal System/2) interface, and so on.

The storage unit 11 is for storing information. The information includes various kinds of data, typically private files/documents.

The keys 115 are configured for password operational inputs. The keys 115 can be in the form of number keys, letter keys, or a combination of the number keys and letter keys. Furthermore, the keys 115 include an update key for updating a predetermined password.

The coordinate output circuit 116 is configured for outputting coordinates corresponding to a movement of the mouse 11 to the microcontroller 113, which in turn transmits the coordinates to the computer system 10 through the interface 110.

The button/scroll wheel control circuit 117 is configured for generating input signals corresponding to operational inputs on buttons (e.g., left button, middle button, and right button) or a scroll wheel (not shown) of the mouse 11 to the microcontroller 113. The microcontroller 113 transmits the input signals from the button/scroll wheel control circuit 117 to the computer system 10 through the interface 110.

The pressure sensor 112 is preferably configured at the bottom of the mouse 11 for sensing pressure thereon. Accordingly, the pressure sensor 112 is able to generate pressure sensing signals if the mouse 11 is kept upright on a support surface, whereas, the pressure sensor 112 does not generate the pressure sensing signals if the mouse 11 is not kept upright on the support surface. For example, if the mouse 11 is placed sideways or is in an overturned state, the pressure sensor 112 is not pressed, thus not generating the pressure sensing signals.

The microcontroller 113 scans the pressure sensing signals generated by the pressure sensor 112 in real time. In this exemplary embodiment, if a duration of not detecting the pressure sensing signals reaches a predetermined value, the microcontroller 113 generates and transmits a lock signal to the locking unit 114. In response to the lock signal, the locking unit 114 performs a lock operation on the storage unit 111, thereby preventing unauthorized access to the storage unit 111.

Therefore, a user can promptly and conveniently lock the storage unit 11 through a simple operation on the mouse 11 such as, for example, turning over the mouse 11 or placing the mouse 11 sideways.

The microcontroller 113 further includes a password comparing module 1130 and an unlocking module 1131. The password comparing module 1130 compares the password operational inputs from the keys 115 with the predetermined password, and generating an unlock signal if the password operational inputs match the predetermined password. In response to the unlock signal, the unlocking module 1132 unlocks the storage unit 111, thereby enabling the computer system 10 to access the storage unit 111. Otherwise, the computer system 10 cannot access the storage unit 111, i.e., if the password operational input does not match the predetermined password, thereby preventing unauthorized access to the storage unit 111.

The password comparing module 1130 further updates the predetermined password with the password operational inputs following the operational input of the update key, thereby enhancing the security of the information stored in the storage unit 111.

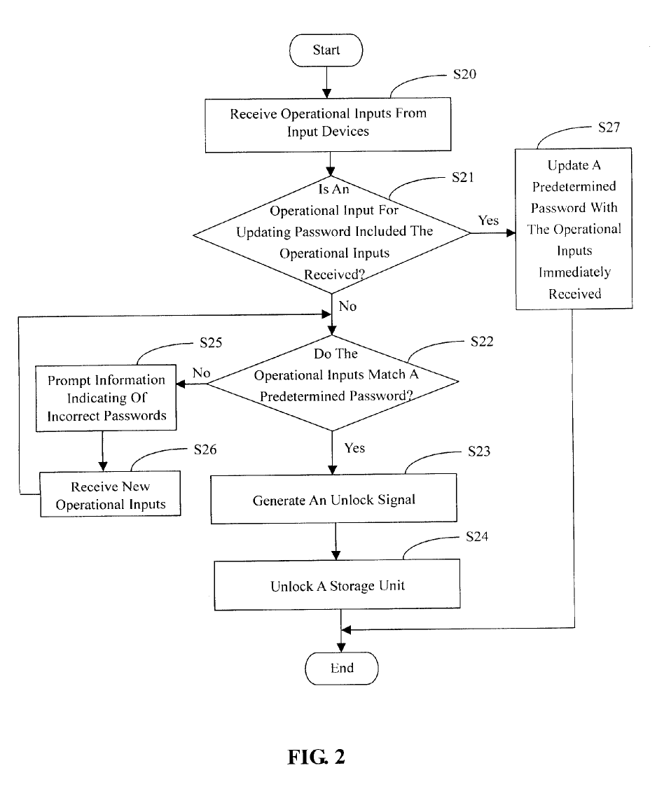

FIG. 2 is a flowchart of a preferred password control method used in the input device of FIG. 1. In step S20, the microcontroller 113 receives the operational inputs from the keys 115. In step S21, the microcontroller 113 detects whether it receives the operational input from the update key, that is, the microcontroller 113 detects whether the operational inputs include the operational input for updating the password. If detecting the operational input from the update key, the procedure goes to step S27 described below.

If not detecting the operational input from the update key, namely where the operational inputs are for password operational inputs, in step S21, the password comparing module 1130 compares the password operational inputs with the predetermined password.

If the password operational inputs match the predetermined password, in step S22, the password comparing module 1130 generates the unlock signal. In step S23, the unlocking module 1131 unlocks the storage unit 111, thereby enabling the computer system 10 to access the storage unit 111, and the procedure is finished.

If the password operational inputs do not match the predetermined password, in step S25, the password comparing module 1130 prompts information indicating of incorrect password inputted on the display 118. In step S26, the password comparing module 1130 receives new password operational inputs from the keys 115, and the procedure goes to step S22 described above.

In step S27, namely where the operational inputs for updating the predetermined password, the password comparing module 1130 updates the predetermined password with the operational inputs following the operational input from the update key, thereby enhancing the security of the information stored in the storage unit 111, and the procedure is finished.

Although the present invention has been specifically described on the basis of a preferred embodiment and preferred methods thereof, the invention is not to be construed as being limited thereto. Various changes or modifications may be made to the embodiment and method without departing from the scope and spirit of the invention.

What is claimed is:

1. An input device with a password control function, the input device comprising:
a coordinate output circuit being configured for outputting coordinates corresponding to a movement of the input device;
a plurality of keys for generating operational inputs when pressed, wherein the keys are selected from the group consisting of number keys, letter keys, and a combination of number keys and letter keys;
a storage unit for storing information, wherein the storage unit is not allowable for access when it is in a locked state;
a microcontroller for outputting the coordinates from the coordinate output circuit to a computer system connected thereto, the microcontroller further comprising:
a password comparing module for comparing the operational inputs from the keys with a predetermined password, and generating an unlock signal if the operational inputs match the predetermined password; and
an unlocking module for unlocking the storage unit in response to the unlock signal from the password comparing module, thereby enabling the computer system to access the information of the storage unit.

2. The input device according to claim 1, wherein the keys further comprise an update key for updating the predetermined password.

3. The input device according to claim 2, wherein the password comparing module updates the predetermined password with the operational inputs following the operational input from the update key.

4. The input device according to claim 3, further comprising a display for displaying information related to the operational inputs from the keys.

5. A password control method used in an input device, wherein the input device has a coordinate output circuit for outputting coordinates corresponding to a movement of the input device and a storage unit for storing information, the method comprising the steps of:
providing the input device with a plurality of keys for operational inputs, wherein the keys are selected from the group consisting of number keys, letter keys, and a combination of number keys and letter keys;
comparing the operational inputs from the keys with a predetermined password;
generating an unlock signal if the operational inputs match the predetermined password; and
unlocking the storage unit in response to the unlock signal, thereby enabling a computer system connected thereto to access the information of the storage unit.

6. The method according to claim 5, further comprising the step of: outputting the coordinate inputs from the coordinate output circuit to the computer system.

7. The method according to claim 5, further comprising the steps of:
providing the input device with an updating key for updating the predetermined password; and
updating the predetermined password with the operational inputs following the operational input from the update key.

8. The method according to claim 5, further comprising the steps of:
providing the input device with a display; and
displaying information related to the operational inputs from the keys on the display.
